(19) United States
(12) Patent Application Publication
(10) Pub. No.: US 2025/0350781 A1
(43) Pub. Date: Nov. 13, 2025

(54) OPTIMIZED MEDIA CONTENT MONITORING

(71) Applicant: Q'LIGENT CORPORATION, Melbourne, FL (US)

(72) Inventors: Brick Eksten, Uxbridge (CA); Andrey Gaynulin, Nizhny Novgorod (RU)

(21) Appl. No.: 19/201,586

(22) Filed: May 7, 2025

Related U.S. Application Data
(60) Provisional application No. 63/643,675, filed on May 7, 2024.

(51) Int. Cl. H04N 21/24; H04N 21/845

(52) U.S. Cl. CPC H04N 21/2407; H04N 21/8456

(57) ABSTRACT

A system for monitoring media content distributed from a source to an end point over a network. The content is segregated into a plurality of unique objects before the content is loaded on the network. At the content source, technical source parameters are determined and stored for each object.

At the end point, technical end point parameters are determined for each object. To determine a quality of the content as received at the end point, the end point parameters are compared with the source parameters.

### CROSS REFERENCE TO RELATED APPLICATIONS

The present application claims priority under 35 U.S.C. 119 (e) to the provisional patent application filed on May 7, 2024 and assigned application No. 63/643,675 (Attorney Docket 15258-005). The provisional application is incorporated herein its entirety

### BACKGROUND OF THE INVENTION

The television industry has as its ongoing business model, the requirement to deliver scheduled content in a linear fashion. Linear in this case means a contiguous stream of content delivered in a time-ordered fashion against a schedule that has been determined ahead of time.

From the consumer perspective, this is traditional television viewing experience where content is selected from a guide, schedule, or library and consumed as a stream of continuous video. That video can be played uninterrupted, paused, rewound, or fast forwarded as dictated, under control of the content rights owner.

There also exists a set of regulations and contractual requirements for every delivery channel over which content is delivered in a linear fashion. These requirements, which consist of federal regulations, state and local requirements, contractual obligations to content partners, and obligations to the consumers themselves. These regulations and contracts require that the content provider retain recordings of the telemetry and content itself as proof of what was delivered to the consumer. An example of these regulations is the Calm Act, where the audio levels in programs and commercials must meet a specific set of requirements such that the consumer does not need to constantly adjust the volume of the viewing devices to match the audio level between program and commercial (advertising) content. Other regulatory or contractual examples relate to the content itself, for example, where nudity and violence may be strictly controlled and monitored.

Content owners and/or distributors intend to move from a model of distributing common content channels to all consumers in the network to one that allows them to create variants of content channels to targeted groups within the network. To accomplish this, the content owner must be able to provide measurement, telemetry, and key information for each delivered channel, and this in turn may require expensive computational power and the retention of recordings as evidence of delivery, which in turn requires significant storage media.

FIG. 1 depicts a traditional linear television system comprising channels 1, 2 through n with each channel encoded by an encoder 10, 12, and n according to the content and the technical parameters of the expected distribution channel. The content and the condition of the distribution channel is typically monitored at several stages M1 and M2. At a minimum, the content and distribution channel are monitored at each stage where the content is expected to be modified by the production or distribution process, up to the point where the content is delivered via an appropriate distribution system 32 to consumers 34.

The distribution systems 32 include satellite distribution, off air terrestrial television broadcast, and various networks. Each distribution system is represented by an appropriate icon within the distribution systems block 32. Other possible distribution channels are known to those skilled in the art.

Most content owners and distributors will additionally monitor post distribution at M3 to validate that the distribution system, be it satellite, across networks, or off air (television broadcast) is properly delivering the content at the correct signal levels, formats, and in the correct window of time. The regulatory and contractual obligations that exist for each content distributor are such that they must monitor each unique channel of content that is being delivered, which for most systems means once per common channel that is delivered to all households or consumers within their distribution system.

Since all traditional distribution systems distribute content utilizing a multicast protocol, all channels are common to all users in the system. An example of this is a direct to home satellite service where every home has a satellite dish pointed at the same satellite(s) and all consumers are potentially receiving the same unmodified channels. This aligns the cost of monitoring to the number of times the content is modified pre-distribution (M1 and M2) and to the number of common signals delivered to the consumers. Where recording of content is required to meet regulator or contractual obligations, recordings are similarly limited to just one per unique channel delivered.

The popularity of OTT (over the top) content delivery (e.g., Netflix) has motivated distributors and content owners to create a new business model of multiple new channel variants, each which targets a sub-group of the audience, in effect, creating multiple unique channels of content, each tailored for a sub-group of consumers. This can happen at any scale, such as country, region, city, neighborhood, and an individual consumer.

An example of OTT distribution is two groups of consumers located in separate cities watching the same sports channel, with a promotional clip aired during a break in the sporting event. The clip provides highlights of each local team to the two groups of consumers. Other examples include weather updates, local breaking news, and targeted advertising. This content delivery model substantially increases the number of monitoring points in the network, increasing cost and complexity for managing contractual and regulatory compliance obligations.

Contractual and regulatory obligations may require accountability by measuring the delivered content for each unique channel created. This scheme dramatically expands the number of monitoring points (M3, M4, M5, to −M(n) in FIG. 2) in the network, with unique content (a common signal) delivered to each group of consumers 40, 42, 44, and 46, respectively. If a recording is required, each unique channel creates a unique recording that must be stored for a period of time, between days and years depending on policies and contractual or regulatory requirements of the content owner and content distributor. At very high levels of scale (e.g., complex and multiple channels of content) a large content distributor could potentially deliver millions of channels of unique content. The cost, complexity, and significant number of monitoring points across channel variants is both computationally intensive and cost prohibitive.

### BRIEF DESCRIPTION OF THE DRAWINGS

The present embodiments are illustrated by way of example, and not by way of limitation, in the figures of the accompanying drawings. The following figures are illustrative only, and are not intended to be limiting.

FIG. 1 shows a prior art content delivery system wherein common signals our delivered to a single group of consumers.

FIG. 2 shows a prior art content delivery system with multiple different common signals each delivered to different group of consumers.

FIG. 3 shows a selected content block and its division into a plurality of objects.

FIG. 4 shows the signatures associated with the selected content block of FIG. 3.

FIG. 5 shows an embodiment for comparing object signatures at the source and destination ends.

FIG. 6 shows an embodiment for comparing object signatures at the source and destination ends and at a network point between the source and destination ends.

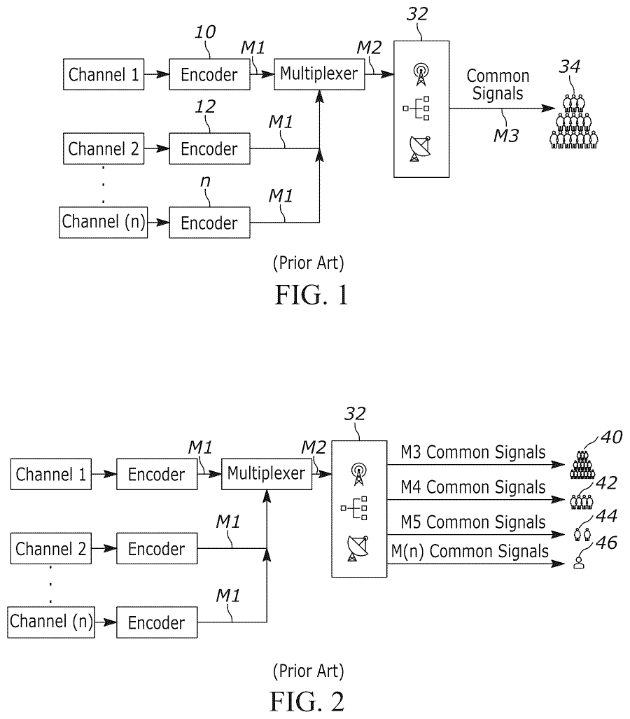

### DETAILED DESCRIPTION OF THE INVENTION

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art of this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

The terms electromagnetically coupled, inductively coupled, and non-contact heating tend to be used interchangeably throughout this disclosure and generally have the same meaning. The terms heating element, interior vessel or reactor wall, magnetic material, magnetic heating element, and high u material also tend to be used interchangeably in this disclosure and generally have the same meaning. Similarly, the terms heat source, and AC excitation magnet, and coil tend to be used interchangeably throughout this disclosure and generally have the same meaning. The terms container, vessel, and reactor generally have the same meaning and tend to used interchangeably throughout this disclosure.

The inventive method comprises multiple steps or actions as set forth below.

All content is first segregated into “n” objects, each of which is unique and together the n objects comprise the entire content during a specified time interval. The objects are then stored in the network's central database and cataloged (registered).

An object may be defined by a plurality of parameters, and the object may compromise an entire segment of a show or movie, a sub segment based on its data size, or the length of playback (in time).

As used herein a show is defined as live or prerecorded media presentation having a logical beginning and end that is intended for viewing or listening by consumers.

As the content progresses through the content distribution network certain aspects of one or more of the objects may be changed by network anomalies and conditions. These changes will appear as changes in the object measurements and can be compared with the cataloged (registered) content (i.e., the initial measured parameters for that object at the source) as stored in the network database. A distribution network problem is indicated if the object end point measurements do not match the object source measurements. Additionally, the mismatch between source and end point measurements may be due to other non-network anomalies and conditions.

The parameters associated with each object are typically measured individually. Alternatively, a parameter associated with a plurality of objects is measured, based on a logical joinder or construction of multiple objects.

A specific show may be characterized as an aggregate of all parameter measurements of the individual objects that comprise that show. And the individual objects can be described as the totality of the measurements of the content and structure for that object.

The measurements of the individual parameters associated with each object (also referred to as object signatures) are recorded/stored and form a linear stream of object signatures. Note that each signature is a standalone description of the object with which it is associated, and the cumulative content of all object signatures represent the entirety of the original content. Typically, the measurements are performed before the content (and the objects derived from the content) is loaded onto the content distribution network.

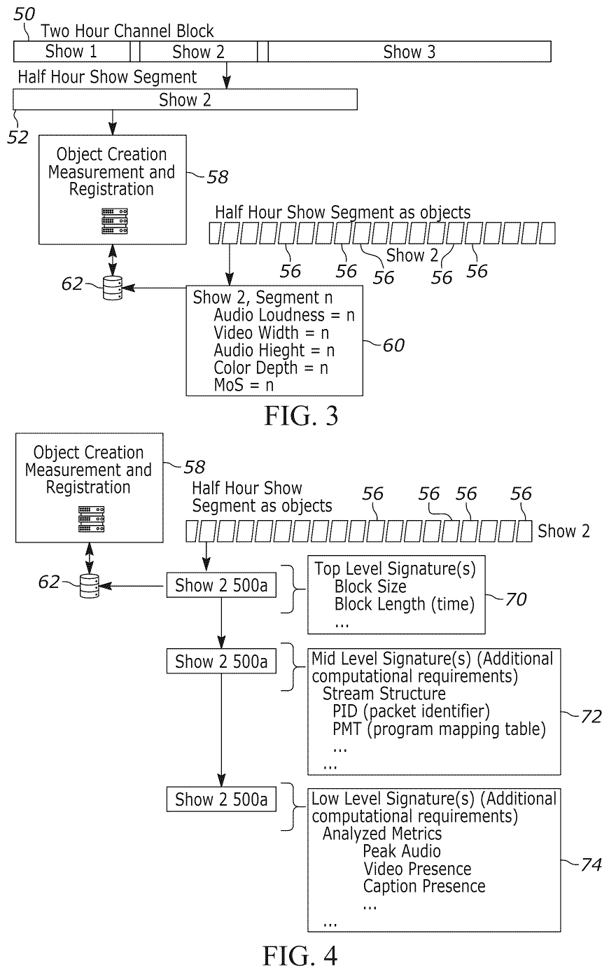

FIG. 3 depicts a two hour channel block 50 comprising show 1, show 2, and show 3. Show 2 is a half hour in length and this half hour show segment is isolated in FIG. 3 to demonstrate the first aspect of the invention. The half-hour show segment 52 is subdivided into a plurality of objects 56 in a step 58 during which multiple objects are created, certain parameters of each object are measured or determined, and the parameters are registered or saved.

As indicated in a block 60, for each n^{th} object exemplary parameters include: audio loudness, video width, video height, color depth, and MoS (e.g., motion only shot or mit out sound). These parameters are measured and stored in memory 62 for each n^{th} object within the half hour segment.

FIG. 4 illustrates exemplary parameters for object 500a of show 2. The measured parameters are divided into top, mid, and low level groups as set forth in blocks 70, 72, and 74. The top level group parameters of block 70 are determined with minimal computational requirements and can therefore be determined on a device with minimal computational horsepower. Additional computational requirements are required for the mid level signatures 72 and still additional computational requirements are required for the low level signatures 74. In this example, the mid level parameters are related to the structure of the content stream and the low level parameters are related to video and audio parameters of the content. The identified parameters for the top 70, mid 72, and low level 74 signatures are merely exemplary as those skilled in the art are familiar with other aspects of the content that can be measured. Other exemplary object parameters of interest not identified in FIG. 4 include, audio loudness, video width, video height, and video format.

The parameters are segregated into the three levels as set forth in FIG. 4 to reflect the computational functionality of the various consumer devices that may be receiving the content. For example, certain smart phones may lack the capability to quicky determine a parameter such as “peak audio” that can be more easily determined by a high-end computer.

The preferred measured parameters for each object are based on the content from which that object was derived. For example, musical performance content may include a plurality of object parameters related to audio fidelity, while measuring audio fidelity for a half hour sitcom is not significant.

In one embodiment, the system of the invention logs identification indicia of the manifests/playlists the consumer watches. The log may include special features of the delivered content, such as whether captions are displayed, the audio language tracks available, and the selected audio track that was delivered with the video. All segment identifiers for the content the consumer receives or watches are also logged.

Performance of the distribution network is measured and successful delivery of the content across the network is determined by comparing the object measurements at the source (stored in the network database) against the object measurements at the destination (consumer). It is not necessary to completely analyze all segment objects to achieve a level of confidence that an object (and thus the content from which the object was derived) has indeed been delivered as intended.

According to various embodiments, delivery success can be determined by analyzing network metrics, player metrics, consumer metrics (that is, metrics derived at the consumer site) and high-level measurements of an object (that is, deriving a top-level signature). Further auditing of delivery can be obtained by combining previously obtained metrics with the lower level signatures (i.e., mid level and low level signatures) of each object and comparing that information against the registered signatures in the network database o wherever the source metrics are stored. Using that information, the system can reconstruct the individual “as watched” content and provide whatever evidence, reporting and compliance for each and any specific user, group, territory, or total audience (with any segmentation as required).

By tracking delivery of the objects, the system creates a unique content delivery receipt that is used to fully reconstruct the content ‘as delivered’ to the consumer or device at the terminal end or end point of the network. The content delivery receipt generated at the delivered end is utilized to validate the quality of service and quality of experience for the delivered content by comparing objects in the content registry to the content delivery receipt.

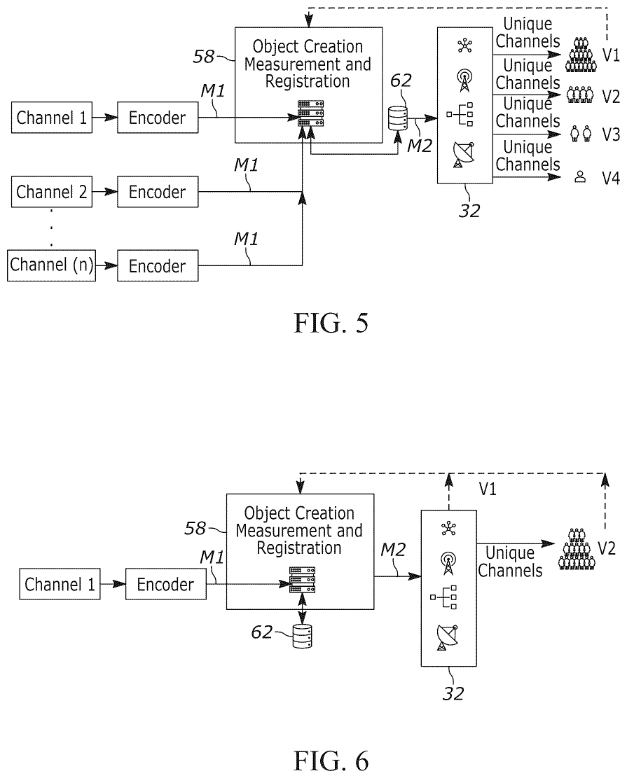

As illustrated in FIG. 5, the computationally intensive measurements are executed prior to delivery at point M2, these measurements may include the top, mid, and low-level object signatures 70, 72, and 74 as set forth in FIG. 4.

The content is validated as delivered to consumer groups s V1, V2, V3, and V4 (see FIG. 5). In one embodiment this validation may use a relatively lightweight signature component that can directly leverage data generated by the computationally-limited consumer application, device, or service. Using this consumer data, a validation ‘receipt’ is generated and compared to the intended schedule system by comparing object signatures in the delivered telemetry to the object original signature at the source. The receipt can therefore serve as proof of delivery. If a more computationally sophisticated device is available at the destination/consumer end, low level and/or mid level signatures may be used to determine delivery and the quality of the delivered content at the consumer end.

In the embodiment represented by FIG. 6 the object signatures are generated at M2, at V1 (at the content distribution network), and V2 (as delivered to the consumer) and compared to the registered signatures that were generated at M2 and stored there in the content database 62 (This embodiment provides individual delivery receipts across the sub-segments of the content distribution network and allows identification of issues and problems between the source and the consumer.

What is claimed is:

1. A system for monitoring media content distributed from a source to an end point over a
content delivery network, the system comprising:
before the media content is loaded onto the network, dividing the media content into a plurality of unique objects;
at the source, determining one or more source parameters associated with each object, wherein the one or more source parameters represent a source signature for the object;
storing the one or more source parameters associated with each object;
determining one or more end point parameters associated with each object as received at the end point, wherein the one or more end point parameters represent an end point signature for the object; and
monitoring the media content as received at the end point by comparing the source signature and the end point signature.

2. The system of claim 1, wherein the one or more source parameters and the one or more
end point parameters relate to audio or video characteristics of an object.

3. The system of claim 1, wherein the one or more source parameters and the one or more end point parameters relate to audio loudness, video width, video height, color depth, MoS, block size, block length in time units, packet identifier, peak audio, video presence, and caption presence.

4. The system of claim 1, wherein the one or more source parameters and the one or more end point parameters relate to parameters of an object that could experience a change while traversing the network from the source to the end point.

5. The system of claim 1, wherein the network comprises a terrestrial broadcast network, an internet, and a satellite broadcast network.

6. The system of claim 1, further comprising issuing a received receipt indicating differences between the source and endpoint parameters.

7. The system of claim 1, wherein values of the one or more source parameters are determined at one or more network locations between the source and the endpoint.

8. The system of claim 1, wherein at the end point a consumer device receives the media content.

9. The system of claim 1, wherein the one or more source parameters and the one or more end point parameters are responsive to a content type.

10. The system of claim 1, wherein the one or more source parameters and the one or more end point parameters are same parameters.

11. The system of claim 1, wherein different consumer groups are located at different end points, each one of the different consumer groups receiving different media content, and wherein consumer group parameters are determined for an object for each different consumer group and represent a consumer group signature for the object for each different consumer group.

12. The system of claim 11, determining a quality of each different media content by comparing the source signature with each consumer group signature.

13. The system of claim 1, wherein an object comprises audio content, video content, and audio/video content.

14. The system of claim 1, wherein one of the one or more source parameters and one or more of the end point parameters represents a technical attribute of an object.

15. The system of claim 1, wherein a level of detail revealed by the one or more source parameters and the one or more end point parameters is responsive to a granularity of the objects.

16. The system of claim 1, wherein a step of monitoring determines a quality of the media content as received at the endpoint by comparing the source signature and the destination signature.

17. The system of claim 1, wherein the one or more source parameters and the one or more end point parameters relate to a quality of the media content.

18. The system of claim 1, wherein end point parameters are selected responsive to the computational capability of an end point device receiving the media content.

19. A system for monitoring media content distributed from a source to an end point over
a network, the system comprising:
before the media content is loaded onto the network, dividing the media content into a plurality of unique objects;
at the source, determining one or more source parameters associated with an object, wherein the one or more source parameters represent a source signature for the object;
storing the one or more source parameters associated with each object;
determining one or more network site parameters associated with the object as received at a network site between the source and the end point, wherein the one or more network site parameters represent a network site signature for the object;
determining one or more end point parameters associated with the object as received at the end point, wherein the one or more end point parameters represent an end point signature 5 for the object;
monitoring a quality of the media content as received at the network site by comparing the source signature and the network site signature; and
monitoring a quality of the media content as received at the end point but comparing the source signature and the end point signature or by comparing the network site signature and the end point signature.

20. The system of claim 19, further comprising issuing one or more received receipts indicating differences between the source and endpoint parameters, between the source and network site parameters, or between the network site and end point parameters.
